(19) United States
(12) Patent Application Publication
(10) Pub. No.: US 2021/0065130 A1
(43) Pub. Date: Mar. 4, 2021

(54) PERSONAL INFORMATION PLATFORM SYSTEM INCORPORATING BIG DATA AND ARTIFICIAL INTELLIGENCE

(71) Applicant: Yu-Ting LEE, Taipei City (TW)

(72) Inventor: Yu-Ting LEE, Taipei City (TW)

(21) Appl. No.: 16/880,476

(22) Filed: May 21, 2020

(30) Foreign Application Priority Data
Aug. 28, 2019 (TW) 108130838

(51) Int. Cl. G06Q 10/10; G06N 5/04; G06F 16/28; G06Q 40/08; G06Q 50/20; G06Q 30/06; G09B 19/00

(52) U.S. Cl. CPC G06Q 10/1053; G06N 5/043; G06F 16/283; G06Q 10/1097; G09B 19/00; G06Q 40/08; G06Q 50/2057; G06Q 30/0625; G06Q 10/1057

(57) ABSTRACT

A personal information platform system incorporating big data and artificial intelligence (AI) includes a job matching platform, a vocational training platform, a transaction platform, a group management platform, and a personal information platform for linking the foregoing four platforms together. The system also includes a big data database and an AI server. Once in operation, the system generates big data associated with the Internet, the Internet of things, and social networks, and performs AI deep learning, artificial neural network-based learning, or open-source framework-based learning in order to find the most effective customized suggestion and plan for an individual user, set regional parameters, and carry out quantitative integration.

### BACKGROUND OF THE INVENTION

### 1. Technical Field

The present invention relates to a personal information platform system. More particularly, the invention relates to a personal information platform system that incorporates big data and artificial intelligence and has job matching, vocational training, transaction, and group management functions.

### 2. Description of Related Art

The world is now in an era of information explosion, making it essential for us to find a way to precisely and promptly extract the information we need from a vast amount of information. In the meantime, progresses made in the fields of algorithms, computation, and big data have spurred the rapid development of artificial intelligence (AI), allowing us to take the fruit of technological advancements and live better lives. The aforesaid technologies, however, fail to meet our needs more effectively as they gradually mature, and their applications are therefore quite limited, which demands improvement.

It is an important issue for those involved in the related industries, including the inventor of the present invention, to study and solve the foregoing problems of the prior art.

### BRIEF SUMMARY OF THE INVENTION

In view of the prior art problems stated above, the inventor of the present invention performed a comprehensive assessment on the data collected, conducted repeated trials and modifications based on years of practical experience in the industry, and finally succeeded in developing the system disclosed herein.

One objective of the present invention is to provide a personal information platform system that incorporates big data and AI and has job matching, vocational training, transaction, and group management functions.

To achieve the above and other objectives, the personal information platform system incorporating big data and AI according to the present invention includes a user electronic device, a personal information server, a big data database, and an AI server. The user electronic device is installed with a personal information application program. The personal information server is connected to the user electronic device through the Internet so that a user can connect to the personal information server via the personal information application program. The personal information server includes a personal information platform, a job matching platform, a group management platform, a vocational training platform, and a transaction platform. The personal information platform includes a task reminder module for reminding the user of at least one task to be done, and a history record module for recording the process of the user performing the at least one task. The job matching platform is connected to the personal information platform and is configured to publish hiring information for the user or allow the user to search for hiring information thus published. The group management platform is connected to the personal information platform and is configured to manage the user's basic information, the user's labor insurance and health insurance, and the user's documents. The vocational training platform is connected to the job matching platform and the group management platform and is configured to provide vocational training to the user. The transaction platform is connected to the personal information platform and is configured to publish a to-be-sold product for the user when the user wishes to sell the to-be-sold product, or allow the user to search for and buy a to-be-sold product thus published. The big data database is configured to store plural entries of big data. The AI server is connected to the personal information server and the big data database and is configured to analyze the plural entries of big data and perform AI-based computation in order to obtain an optimized suggestion to be supplied to the personal information server.

In one preferred embodiment, the user electronic device may be a personal computer, a smartphone, or a tablet computer.

In one preferred embodiment, the hiring information includes a job position, a description of the job position, the wage or salary of the job position, or the working location of the job position.

In one preferred embodiment, the plural entries of big data include life history data and lifespan data.

In one preferred embodiment, the optimized suggestion may be a job matching suggestion, a vocational training suggestion, or a transaction suggestion.

In one preferred embodiment, the transaction platform is further connected to the job matching platform and the group management platform.

### BRIEF DESCRIPTION OF THE SEVERAL VIEWS OF THE DRAWINGS

The technical means and structure adopted by the present invention to achieve the aforesaid objective and effects can be better understood by referring to the following detailed description of the features and functions of a preferred embodiment of the invention in conjunction with the accompanying drawings, in which:

FIG. 1 is a block diagram of the personal information platform system incorporating big data and AI according to a preferred embodiment of the present invention; and

FIG. 2 is another block diagram of the personal information platform system in FIG. 1.

### DETAILED DESCRIPTION OF THE INVENTION

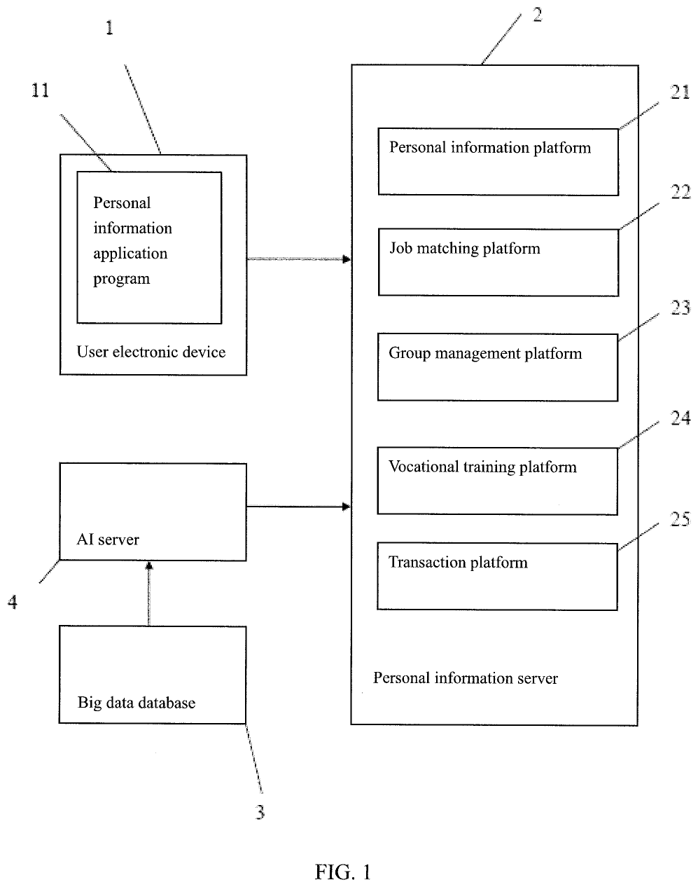

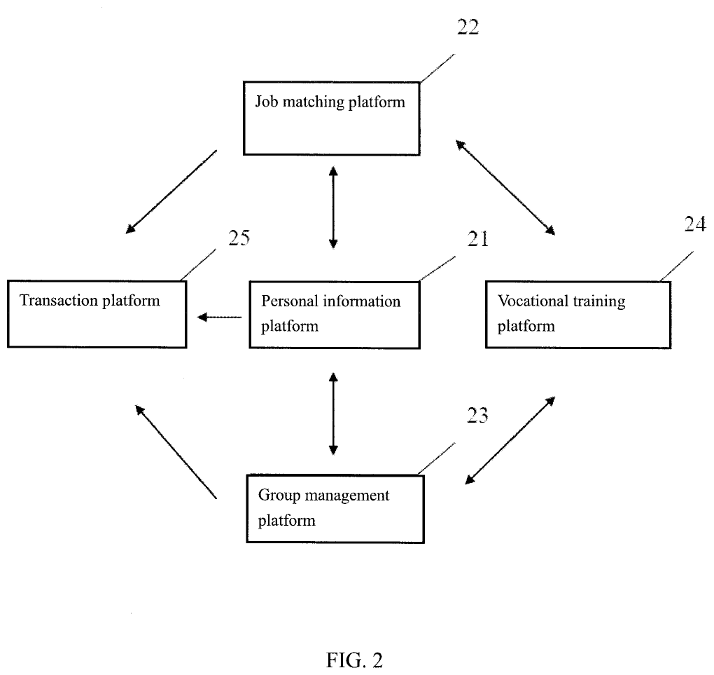

Please refer to FIG. 1 and FIG. 2 for two block diagrams of the personal information platform system incorporating big data and AI according to a preferred embodiment of the present invention. The drawings clearly show that the personal information platform system incorporating big data and AI includes a user electronic device 1, a personal information server 2, a big data database 3, and an AI server 4.

The user electronic device 1 is installed with a personal information application program 11. The user electronic device 1 may be a personal computer, a smartphone, or a tablet computer and in this embodiment is a smartphone by way of example. The personal information application program 11 may be an application program for use in smartphones, such as a third-party application program downloaded from the iTunes store of Apple or through the Android Market software for the Android operating system.

The personal information server 2 is connected to the user electronic device 1 through the Internet so that a user can connect to the personal information server 2 via the personal information application program 11. The personal information server 2 includes a personal information platform 21, a job matching platform 22, a group management platform 23, a vocational training platform 24, and a transaction platform 25.

The personal information platform 21 includes a task reminder module and a history record module. The task reminder module is configured to remind the user of at least one task to be done. Preferably, the task reminder module is shown as a calendar or a notepad; can be switched between a yearly calendar, a weekly calendar, a daily calendar, and so on; and provides a reminder of the time or place of the task to be done. The task to be done may be, for example, the action to be taken in response to a job interview notice or a vocational training notice. The history record module is configured to record the process of the user performing the at least one task.

The job matching platform 22 is connected to the personal information platform 21 and is so configured that the user can publish hiring information on the job matching platform 22 or search for hiring information published on the job matching platform 22. Preferably, the hiring information includes a job position, a description of the job position, the wage or salary of the job position, or the working location of the job position. The job matching platform 22 may also include a job interview module with which the user can make a job interview appointment with the company offering the interview (i.e., determine the time and place of the interview), and an assisting module for reminding the user of the time of the interview and for navigating the user to the place of the interview.

The group management platform 23 is connected to the personal information platform 21 and is configured to manage the user's basic information, to manage the user's labor insurance and health insurance, and to manage the user's documents. Preferably, managing the user's basic information includes managing such information as the user's name, age, and skills; managing the user's labor insurance and health insurance includes allowing the wage/salary brackets of the user's labor insurance and health insurance to be browsed and set; and managing the user's documents includes managing such electronic documents as applications, corroborating documents, and official documents issued by government agencies.

The vocational training platform 24 is connected to the job matching platform 22 and the group management platform 23 and is configured to provide vocational training to the user. Preferably, the vocational training platform 24 includes an evaluation module with which the user can evaluate the degree of satisfaction of the vocational training received. Preferably, the vocational training provides technical skill training (e.g., a course of cooking skills when the user is an employee requiring those skills) or management skill training (e.g., a course of management skills when the user is an employer requiring those skills); hence, the vocational training platform 24 can be used to obtain professional certification. Once the training is completed, the user may evaluate the degree of satisfaction of the training course by way of the evaluation module.

The transaction platform 25 is connected to the personal information platform 21 and is so configured that the user can publish a to-be-sold product on the transaction platform 25 in order to sell the to-be-sold product, or can search for and buy a to-be-sold product published on the transaction platform 25. In this embodiment, the transaction platform 25 is further connected to the job matching platform 22 and the group management platform 23.

The big data database 3 is configured to store plural entries of big data, which include life history data and lifespan data.

The AI server 4 is connected to the personal information server 2 and the big data database 3 and is configured to analyze the plural entries of big data and perform AI-based computation in order to obtain an optimized suggestion to be supplied to the personal information server 2, wherein the optimized suggestion may be a job matching suggestion, a vocational training suggestion, or a transaction suggestion.

As stated above, it is essential for us, who live in an era of information explosion, to find a way to precisely and rapidly extract the information we need from a vast amount of information, and thanks to progresses made in the fields of algorithms, computation, and big data, the development of AI has gathered speed, allowing us to take the fruit of technological advancements and live better lives. The core concept of the present invention, therefore, is to provide big data analysis and customized AI services. Having detailed the structure and composition of the invention, the present specification continues to describe how the system of the invention is used.

The platform system of the present invention is user-oriented and aims to link personal information, employment records, skill training records, transaction records, and so on with one another. More specifically, the first stage is to accumulate personal data, and the second stage is to compare and analyze the big data obtained and identify the differences and similarities therein so as to provide each user with customized services and perform the desired analysis and computation whenever needed. The foregoing functions can be used as basic templates to develop options suitable for individual users or user groups, or for user analogy-based quantification. A user can log on to the personal information platform 21 via a mobile device or a computer, without being subject to the limitations of location or time, meaning the user can use the functions of the platform at any time to search for history records related to work, training, or transaction and access integrated network information in order to manage and use the work records, skill upgrade records, and transaction records effectively.

One who wishes to have authorized access to the job matching platform 22, the vocational training platform 24, the transaction platform 25, the personal information platform 21, and the group management platform 23 must join, and obtain the membership of, a group using the system of the present invention. The job-matching AI block will perform job matching for a system user according to the information they provide, and produce a job matching list based on such conditions as working location, working time, hourly wage, and professional skills.

If the user has had their skills upgraded or has received training for a second expertise through the vocational training platform 24, the system will publish the training result in the user's personal information field. The job matching platform 22 will then recommend job positions related to the new skills for which the user has been trained, or the user may sell products made with the new skills by publishing the products on the transaction platform 25. In either case, the user's real income is expected to increase, and the user's revenue-generating ability, enhanced by transforming the learning result into an expertise. Also, the job matching system will record the user's current job and income, the group management platform 23 will ascertain whether the user has labor insurance and health insurance, and the transaction platform 25 will record the time, monetary amounts, and quantities of transactions, helping the user to manage their assets and expenses. Thus, the system of the present invention provides management through big data analysis and customized AI services.

The various platforms in the system of the present invention can function as a whole or individually so as to carry out work management and increase users' income. The personal information platform 21, the job matching platform 22, the vocational training platform 24, the transaction platform 25, and the group management platform 23 are assisted by big data analysis and AI-based computation to achieve accumulation of information and circulation and recirculation of demands.

The system of the present invention is user-oriented and provides such functions as job hunting, hiring, skill upgrade, transaction, and process control, the goal being to enable circulation and recirculation of people flow (under self-management throughout system operation), logistics flow (with validation of buyer-seller history records), and money flow (transaction made easy, and with good faith and credit rating).

The group management platform 23 uses “group” as its working unit and is designed to assist in group member management. The term “group” refers to a man-based organization such as but not limited to a labor union, a company, a guild, an association, an institution, a party, or a school. When a natural person joins such a group, the service staff of the group will key in the person's information in order to control the person's entry into and withdrawal from the group, calculate receivables and fees, perform the required accounting process, manage the person's photos and related documents in a paper-free manner (e.g., as image files), check the person's labor insurance and health insurance data, assign jobs to the person, and so on. To ensure that group operations are conducted smoothly, a group may have additional special functions if a corresponding demand is made, and all such demands shall be recorded for future inquiry.

Regarding the job matching platform 22, a natural person who has joined, and obtained the membership of, a group using the system of the present invention is automatically given access to the job matching block. Each natural person in the group has the identity of an employee as well as an employer, and may provide and access employer information (e.g., to review job qualifications and post job openings in the capacity of an employer, and to provide the contents of the employer's blog, i.e., the text and images of the blog, including for example descriptions, promotional activities, and the employer's self-introduction) and employee information (e.g., to provide a professional certificate or a training certificate in the capacity of an employee, to activate the job matching function, and to provide the contents of the employee's blog, i.e., the text and images of the blog, including for example descriptions, promotional activities, and the employee's self-introduction). Feasible job matching modes include but are not limited to pairing an employer with an employee, an employer hiring an employee, and an employer contracting with an employee.

Once a job matching list is produced according to user-set conditions or system recommendations, a user can choose a job from the list as an employee, and a working process begins after the match between the employee and the employer is established. The employee clocks in when starting to work and clocks out when work is finished. The clock-in and clock-out data are verified by the employer, before the system calculates the working fee. The payment and receipt of the fee are verified by the system to conclude the working process.

Should an abnormal condition occur during the working process, the employee may take a picture, or make a video recording, of the abnormal condition with a mobile phone and upload the picture or video recording via the “abnormality handling” function as evidence. Information about the abnormal condition will also be sent to the group to which the employee belongs, in order for the related personnel in the group to intervene and begin a mediation process. If the mediation is in vain, the related files will be presented to the Labor Department and undergo a labor dispute resolution process.

At the end of the working process, both the employee and the employer are required to rate their degrees of satisfaction with the work, score their satisfaction with each other, and write down their thoughts about the working process. All such records will be registered on the history list and be open to view by other employees and employers.

The vocational training platform 24 provides an online process by which a group can implement the “TTQS talent quality-management system”. The vocational training platform 24 follows the five major steps of TTQS: 1. “Plan”→the basic text description and images of the group are stored as files; 2. “Design”→the design rationale, the plan, and the related images of a training course are prepared; 3. “Do”→forms and tables for recording the execution of a training course are prepared and printed out; 4. “Review”→a training course is checked while in progress, and the course-offering department reviews the execution of the course after the course is completed, with a view to upgrading the course; and 5. “Outcome”→one who has completed a training course will be awarded a certificate, may consign physical products of the course to a marketplace for sale if the products are produced, and will have the course certificate registered into the job matching platform as an addition to the person's experience and abilities if a new skill is learned or an existing skill is upgraded, and the system will compute, and thereby produce a report of, the performance of an entire class that have taken a training course.

A group using the system of the present invention may offer training courses according to demands for such courses. An employee having completed a training course should be able to apply what they learned to their work, and the employer should give a score of satisfaction according to the progress the employee has made. The employee may also evaluate their degree of satisfaction with the course they have completed.

Regarding the transaction platform 25, a natural person who has joined a group using the system of the present invention is given a system account that has been activated so that the person can use such functions of the transaction platform 25 as buying/selling products and participating in auctions. After each transaction, the buyer and the seller may score their satisfaction with each other (with images, text, or audio/video files uploaded to the platform), thus providing a mechanism by which incompetent buyers and sellers can be phased out. Blogs (which include images, text, and audio/video files) may be linked to shopping carts and the logistics flow to produce the “what you see is what you get” effect. To users who act as sellers, the platform may provide reports related to PSI (purchase, sales, and inventory), invoice management, accounts receivable, cost analysis, customer group analysis, and so on.

The personal information platform 21, which may be referred to as a “social hall”, is the hub of the system of the present invention. The carrier of the personal information platform 21 is typically a smartphone, and all the functions described above are shown on the personal information platform 21 in an alternate manner. A natural person using the system can benefit from the circulation and recirculation of system functions, which not only feature an integration of multiple functions (including the task reminder function), but also help increase the person's professional skills and income and thereby improve the person's living standard.

Referring to the accompanying drawings, implementation of the present invention can produce the following advantages over the prior art: The various platforms in the system of the invention can function as a whole or individually so as to carry out work management and increase users' income. More specifically, the personal information platform 21, the job matching platform 22, the vocational training platform 24, the transaction platform 25, and the group management platform 23 can be used separately or in conjunction with one another in a circulating manner, allowing users to find jobs with the guaranteed basic income through the job matching platform 22, to upgrade or increase their skills through the vocational training platform 24, to have an increase in income through the transaction platform 25, and to have their insurance benefits secured through the group management platform 23. The system of the invention performs big data analysis and AI-based methods to enable circulation and recirculation of information and integrate multiple functions together (including the task reminder function), thereby achieving individual- or group-based customization and analogous quantification to help enhance users' living standards.

The embodiment described above is only a preferred one of the present invention and is not intended to be restrictive of the scope of the invention. Any simple modification or equivalent structural variation that is based on the disclosure of the present specification and the accompanying drawings shall fall within the scope of the invention.

What is claimed is:

1. A personal information platform system incorporating big data and artificial intelligence (AI), comprising:
a user electronic device installed with a personal information application program;
a personal information server connected to the user electronic device through the Internet so that a user is able to connect to the personal information server through the personal information application program, wherein the personal information server comprises:
a personal information platform comprising a task reminder module and a history record module, wherein the task reminder module is configured to remind the user of at least one task to be done, and the history record module is configured to record a process of the user performing the at least one task;
a job matching platform connected to the personal information platform and configured to publish hiring information for the user or allow the user to search for hiring information thus published;
a group management platform connected to the personal information platform and configured to manage the user's basic information, the user's labor insurance and health insurance, and the user's documents;
a vocational training platform connected to the job matching platform and the group management platform and configured to provide vocational training to the user; and
a transaction platform connected to the personal information platform and configured to publish a to-be-sold product for the user in order for the user to sell the to-be-sold product, or allow the user to search for and buy a to-be-sold product thus published;
a big data database for storing plural entries of big data; and
an AI server connected to the personal information server and the big data database and configured to analyze the plural entries of big data and perform AI-based computation in order to obtain an optimized suggestion to be supplied to the personal information server.

2. The personal information platform system incorporating big data and AI as claimed in claim 1, wherein the user electronic device is selected from the group consisting of a personal computer, a smartphone, and a tablet computer.

3. The personal information platform system incorporating big data and AI as claimed in claim 1, wherein said hiring information comprises a job position, a description of the job position, a wage or salary of the job position, or a working location of the job position.

4. The personal information platform system incorporating big data and AI as claimed in claim 1, wherein the plural entries of big data comprise life history data and lifespan data.

5. The personal information platform system incorporating big data and AI as claimed in claim 1, wherein the optimized suggestion is selected from the group consisting of a job matching suggestion, a vocational training suggestion, and a transaction suggestion.

6. The personal information platform system incorporating big data and AI as claimed in claim 1, wherein the transaction platform is further connected to the job matching platform and the group management platform.
